(19) United States
(12) Patent Application Publication
(10) Pub. No.: US 2005/0047973 A1
(43) Pub. Date: Mar. 3, 2005

(54) Device for holding a substance library carrier

(75) Inventors: Torsten Schulz, Jena (DE); Eugen Ermantraut, Jena (DE); Thomas Ullrich, Jena (DE); Thomas Ellinger, Jena (DE); Joachim Fischer, Portstendorf (DE); Thomas Kaiser, Jena (DE); Klaus-Peter Mobius, Zollnitz (DE); Siegfried Poser, Jena (DE); Jens Tuchscheerer, Jena (DE); Martin Zieren, Jena (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Clondiag Chip Technologies GmbH, Jena (DE)

(21) Appl. No.: 10/820,269

(22) Filed: Apr. 8, 2004

Related U.S. Application Data
(63) Continuation of application No. PCT/EP02/11313, filed on Apr. 17, 2003.

(30) Foreign Application Priority Data
Oct. 9, 2001 (DE) DE 101 49 684.2

(51) Int. Cl. B01L 9/00

(52) U.S. Cl. 422/104

(57) ABSTRACT

Disclosed are devices for holding a substance library carrier, and which are useful in conducting reactions in which binding between complementary molecules is measured qualitatively or quantitatively. Also disclosed are methods for conducting such reactions in the device.

### CROSS-REFERENCE TO RELATED APPLICATIONS

This application is a continuation of PCT/EP02/11313, filed Oct. 9, 2002, which claims priority on the basis of DE 101 49 684.2, filed Oct. 9, 2001.

### BACKGROUND OF THE INVENTION

The invention relates to a modularly built device for the holding of substance library carriers and its use for the qualitative and quantitative detection of certain molecular target molecules.

Biomedical tests are frequently based on the detection of an interaction between a molecule that is present in a known amount and at a known position (the molecular probe) and an unknown molecule that is to be detected, or unknown molecules that are to be detected (the molecular target molecules). In modern tests, the probes are deposited in form of a substance library onto carriers, the so-called microarrays or chips, so that a sample may be analyzed in parallel with several probes simultaneously (D. J. Lockhart, E. A. Winzeler, Genomics, gene expression and DNA arrays; Nature 2000, 405, 827-836). For the preparation of the microarrays, the probes are typically immobilized in a specified manner on a suitable matrix, as for example the one described in WO 00/12575 (see e.g. U.S. Pat. No. 5,412,087, WO 98/36827) or produced synthetically (see e.g. U.S. Pat. No. 5,143,854).

The detection of an interaction between the probe and the target molecule occurs as follows:

The probe or probes are fixed in specified manner on a certain matrix in form of a microarray. The targets are then brought into contact with the probes in a solution and incubated under defined conditions. As a result of the incubation, a specific interaction between the probe and the target takes place. The binding that occurs as a result is distinctly more stable than the binding of target molecules to probes that are not specific to the target molecule. In order to remove target molecules that have not been specifically bound, the system is washed with appropriate solutions or heated.

Detection of the specific interaction between a target and its probe may occur by a variety of methods normally depending on the nature of the marker which was introduced into target molecules before, during or after the interaction of the target molecule with the microarray. Typically, such markers are fluorescent groups, so that specific target-probe interactions may be read out fluorescence-optically with high local resolution and, in comparison to other common detection methods (particularly mass-sensitive methods), with very little effort (A. Marshall, J. Hodgson, DNA chips: An array of possibilities, Nature Biotechnology 1998, 16, 27-31; G. Ramsay, DNA Chips: State of the art, Nature Biotechnology 1998, 16, 40-44).

Depending on the substance library immobilized on the microarray and the chemical nature of the target molecules, interactions between nucleic acids and nucleic acids, between proteins and proteins as well as between nucleic acids and proteins may be analysed using this test principle (for a review see F. Lottspeich, H. Zorbas, 1998, Bioanalytik, Spektrum Akademischer Verlag, Heidelberg Berlin).

Antibody libraries, receptor libraries, peptide libraries, and nucleic acid libraries are possible as substance libraries that may be immobilized on microarrays or chips. The nucleic acid libraries play by far the most important role.

What is involved here are microarrays, on which desoxyribonucleic acid (DNA) molecules or ribonucleic acid (RNA) molecules are immobilized. For binding of a target molecule (DNA molecule or RNA molecule) labeled with a fluorescent group to a nucleic acid probe of the microarray, it is necessary that both the target molecule and the probe molecule be present in the form of a single-stranded nucleic acid.

Only between such molecules can efficient and specific hybridization take place. Single-stranded nucleic acid target molecules and nucleic acid probe molecules are as a rule obtained by heat denaturation and parameters which are to be optimally selected (temperature, ionic strength, concentration of helix-destabilizing molecules) which ensure that only probes with nearly perfect complementary (corresponding to one another) sequences remain paired with the target sequence (A. A. Leitch, T. Schwarzacher, D. Jackson, I. J. Leitch, 1994, In vitro Hybridisierung, Spektrum Akademischer Verlag, Heidelberg Berlin Oxford).

A typical example for the use of microarrays in biological test methods is the detection of microorganisms in samples in biomedical diagnostics. Here, advantage is taken of the fact that the genes for ribosomal RNA (rRNA) are ubiquitously distributed and possess sequence segments that are characteristic for the respective species. These species-characteristic sequences are deposited onto a microarray in form of single-stranded DNA oligonucleotides. The target DNA molecules to be analysed are first isolated from the sample that is to be analysed and provided with fluorescent markers. The labeled target DNA molecules are then incubated with the probes deposited on the microarray in a solution, non-specific interactions are removed by appropriate washing steps and specific interactions are detected by fluorescence-optical analysis. In this way it is possible to detect e.g. several microorganisms in a sample with a single test simultaneously. In this test method, the number of detectable microorganisms in theory only depends on the number of specific probes that have been deposited on the microarray.

For carrying out these tests in practice, the microarrays or chips are fixed in closed chambers which possess inlets and outlets for exchange of the fluids that are necessary for the washing steps and hybridization steps. Such systems are described e.g. in U.S. Pat. No. 6,287,850 and PCT/EP00/06103.

The chamber described in U.S. Pat. No. 6,287,850 does not possess aggregates by which the chamber may be heated or cooled. However, this would be desirable for a specific control of the hybridization. Moreover, the assembly of the reaction chamber, which contains the chip, is complicated and involves several gluing steps for the purpose of sealing the chamber, giving rise to the risk of contamination.

In PCT/EP00/06103, chambers are described that also contain microarrays. These chambers may be heated, but cannot be cooled. Here too, the chamber is assembled in several steps, and gluing steps for sealing the chamber are necessary. The chambers mentioned in the above documents thus allow only limited manipulation of parameters (heating, cooling etc.), the assembly is susceptible to contamination and the peripheral connections that are desirable for an automation of the detection reaction do not exist or can only be achieved with great effort and expense.

In many tests in biomedical diagnostics the problem arises that before the actual test method takes place, the target molecules first have to be present in sufficient quantities and, for this reason, often have to be amplified from the sample. The amplification of DNA molecules takes place through polymerase chain reaction (PCR). For the amplification of RNA, the RNA molecules have to be converted into the corresponding complementary DNA (cDNA) by means of reverse transcription. This cDNA may then also be amplified by PCR. PCR is a standard laboratory method (J. Sambrook, E. F. Fritsch, T. Maniatis, 1989, Molecular Cloning: A laboratory manual, 2^{nd} edition, Cold Spring Harbor, N.Y., Cold Spring Harbor Laboratory Press).

The amplification of DNA by PCR is relatively fast, allows a high sample throughput in low batch volumes by means of miniaturized methods, and is work-efficient by means of automation. Characterization of nucleic acids solely by means of amplification is however not possible. Rather, it is necessary to use analysis methods such as nucleic acid sequence determinations or electrophoretic separation and isolation methods for the characterization of the PCR products after amplification.

From documents U.S. Pat. No. 5,716,842, DE 195 19 015A1, and WO 94/05414, as well as U.S. Pat. No. 5,498,392, several miniaturizable or miniaturized methods and devices (thermocyclers) for carrying out of the PCR are known. The integration of a microarray or the integration of a DNA chip is not dealt with in these documents.

In documents U.S. Pat. No. 5,716,842, WO 91/16966, WO 92/13967, miniaturizable or miniaturized thermocyclers are described that function according to the principle that the fluid sample is continuously pumped over three temperature zones. These continuously working thermocyclers also do not provide for integration of a DNA chip.

The disadvantage of all of the above-mentioned solutions is that online detection only provides information on whether and possibly how much nucleic acid has been amplified. A better characterization of the amplification products is not possible.

The U.S. patent specification No. 5,856,174 discloses a system, by which it is possible to pump back and forth between three miniaturized chambers. In one chamber of this system the PCR takes place, in the next chamber a processing/purification reaction is carried out, and in the third chamber the reaction products are detected, e.g. on a DNA chip. The miniaturized PCR vessel is a standard vessel of the kind sufficiently described in the literature (S. Poser, T. Schulz, U. Dillner, V. Baier, J. M. Kohler, D. Schimkat, G. Mayer, A. Siebert, Chip element for fast thermocycling, Sensors and Actuators A, 1997, 62672-675). The disadvantage of this arrangement is that a system of pressure-driven fluidics, which is complicated, liable to malfunction and complex to regulate, has to be set up in order to transport the fluid sample from the PCR chamber to the detection chamber. In addition, separating amplification and detection leads to an increase in the overall analysis time.

In PCT/EP00/06103 a unit is described, with which PCR and nucleic acid hybridization may be carried out on a DNA chip as a single chamber reaction in a sample chamber with integrated heating system. However, this unit has the disadvantage that it cannot be cooled, that a complicated quadropol system is necessary for mixing the samples, and that the assembly of this unit requires the gluing of parts. Moreover, this unit, which is a disposable product, is uneconomical because of its high manufacturing costs.

In R. C. Anderson, X. Su, G. J. Bogdan, J. Fenton (A miniature integrated device for automated multistep genetic assays, Nucleic Acids Research, 2000, Vol. 28, No. 12), a finger-thick cartridge is described in which DNA purification steps, PCR, an enzymatic processing and hybridization may be carried out on a DNA chip, the different reactions occurring in different reaction chambers. By means of a complex compressed air-driven unit, the sample solution is pumped from reaction chamber to reaction chamber in order to carry out the different steps of the process. The disadvantages of this system are that a great amount of effort goes into the construction of a pressure-driven fluidics, there is a tendency to malfunction and there are no integrated heating and cooling aggregates. Moreover, only the PCR and the enzymatic processing may be automated.

Considering the mentioned state of the art, it becomes clear that there is a great need for devices that enable the fully automated carrying out of microarray-based detection tests. In particular, there is a need for devices for the carrying out of microarray-based tests in which the control of parameters such as temperature regulation, such as cooling and flow control is fully automated. Furthermore, there is a need for devices for the carrying out of microarray-based tests which allow the in-situ synthesis, e.g. by PCR, of the components required for the test such as the target molecules and the use of the amplification products directly in the test system without manual processing. There is generally a need for devices for the carrying out of microarray-based tests that are characterized by simple construction, easy manageability, avoidance of sources of contamination, reproducibility of the tests, and low manufacturing costs.

### SUMMARY OF THE INVENTION

Hence, it is an object of the present invention to provide a device that allows for the fully automated and parameter-regulated carrying out of microarray-based tests. It is a further object of the present invention to provide a device that is characterized by simple construction, easy manageability and therefore cost-effective manufacturing. Further, it is an object of the present invention to provide a device that allows for the simultaneous performance of PCR and microarray-based tests in a single chamber system by avoidance of sources of contamination. It is a further object of the present invention to provide a manual filling station for the loading of the sample chamber that contains the microarray.

These and other objects of the present invention are solved by providing the subject matter described in the patent claims. Preferred embodiments are defined in the sub-claims. In this connection, the objects are solved according to the invention as follows: by pressing together a layer composite 400, 300, 200 by means of two holding elements (101, 102) that are fixable with one another a device 1 is created that comprises an optically translucent chamber 500 which, in turn has a detection surface having a substance library 201 and in which microarray-based tests as well as reactions such as PCR may be carried out.

This kind of construction and the nature of the components of the layer composite, which are a base element 400, an intermediate element 300, and a lid element 200, are responsible for advantageous effect of the created chamber 500, hereinafter also referred to as sample or reaction chamber. The entire device 1 is hereinafter also referred to as cartridge 1.

The construction of the cartridge 1 and the reaction chamber 500 according to the invention allows the production of cartridges 1 and reaction chambers 500 in which the substance library carrier may be replaced without much effort. Another advantage of this construction principle is that the created reaction chamber 500 is hermetically sealed without having to be glued, which saves several working steps in comparison with the usual assembly of the reaction chamber 500 according to the state of the art. Hence, the device according to the invention as such is better; in addition, potential contamination of the sample space due to the gluing steps is prevented. These and other advantageous properties of the created reaction chamber 500 are based on the nature of the base, intermediate and lid elements forming the reaction chamber.

### BRIEF DESCRIPTION OF THE DRAWINGS

FIG. 1 is a representation of the assembled cartridge 1 consisting of two holding devices 101 and 102, media connection side 120 with data matrix 600, antireflection structure 109, and snap-fit 106 at the media connection side. Furthermore, alignment pin holes 108 are illustrated.

FIG. 2 is a representation of the individual components of the cartridge 1 in an exploded drawing. In the upper part of the picture, a holding device 102, in the middle the core unit 500 consisting of base element 400, intermediate element 300, and lid element 200, in the lower part of the picture, the second holding device 101 is seen.

FIG. 3 is a representation of the cartridge 1 attached to the connector 1000.

FIG. 4 is a representation of the connector 1000 with labeling of the cartridge terminal strip

FIG. 5 is an overview of the opening of the reaction space 301 by cannulae 1201 by means of a slide.

FIG. 6 is a detailed representation of the opening of the reaction space 301 by cannulae 1201 that puncture the sealing septum 300 and form an inlet 1202 and an outlet 1203 in the reaction space 301. The cannulae are positioned toward the sample chamber by the locating lug 1103 on the slide 1100 and the needle guide 113 in the cartridge 1.

FIG. 7 is a representation of the filling station 2000 with installed injection syringe 2401, put on lid 2200, and installed cartridge 1. The filling station 2000 stands on the filling station base 2300 and is held by magnets.

FIG. 8 is representation of the body 2100 of the filling station with installed injection syringe 2401 with cannula 2402 and ventilation cannula 2403.

FIG. 9 is an image of an electrophoresis gel. The mass reference-DNA (one fragment every 100 base pairs) was loaded on lane A, the PCR products that were produced in a conventional thermocycler on lanes B and D, and the PCR products that were produced in the cartridge on lanes C and E. Genomic DNA of Corynebacterium glutamicum was amplified. The amplification product has a length of approx. 500 base pairs. It becomes apparent from FIG. 9, that the cartridge 1 may be used for the amplification of DNA by means of PCR and that it is as equally efficient as a conventional thermocycler.

FIG. 10 is an analysis of the PCR reaction carried out in example 2. Intensive hybridization signals are only detected at the spots that were occupied by the P1-sequence perfectly complementary to the labeled strand of the PCR.

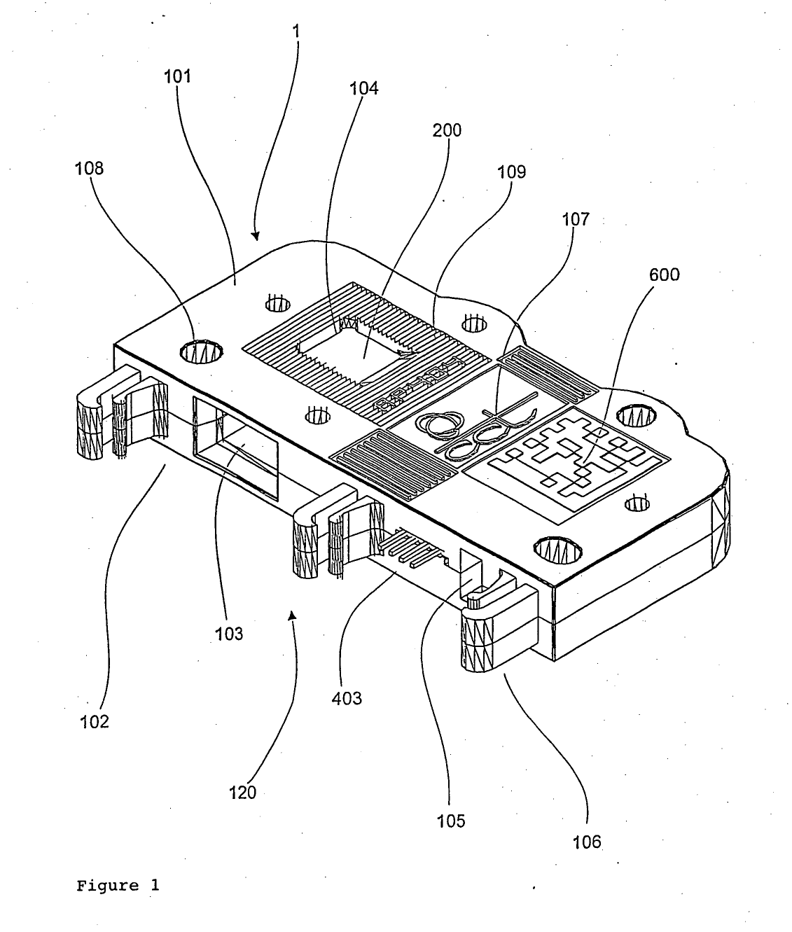

### DETAILED DESCRIPTION

According to the invention, the designation lid element 200 refers to a carrier element 202 that has a substance library 201 on a detection surface and is optically translucent and non-fluorescent, at least within the area of the detection surface. Detection surface means the area of the carrier element 202 on which the substance library 201 is immobilized. In such a preferred embodiment of the invention, the substance library 201 is directly deposited on the lid element 200.

In other preferred embodiments, the substance library 201 is deposited on an optically translucent, non-fluorescent chip which, in turn, is fixedly connected to the carrier element 202 that is, at least in the detection area defined by the chip, optically translucent and non-fluorescent, the dimensions of the chip being smaller than the dimensions of the carrier element 202. In this case, the chip carrying the substance library 201 and the carrier element 202 together forms the lid element 200.

The carrier element 202 consists of optically translucent, non-fluorescent materials. The materials are preferably glass, Borofloat 33 (Schott), quartz glass, monocrystalline CaF₂ (Schott), monocrystalline silicon, phenyl methyl methacrylate, and/or polycarbonate.

If the substance library is not directly deposited on the carrier element 202 but on a chip, the chip also consists of optically translucent, non-fluorescent materials. Preferred materials are glass, Borofloat 33 (available from Schott), quartz glass, monocrystalline CaF₂ (available from Schott), monocrystalline silicon, phenyl methyl methacrylate, and/or polycarbonate.

The substance library may also be located on the base element 400. It is obvious to a person skilled in the art that in this case the lid element 200 consists of a carrier element 202 having an area whose position, size and shape is defined by the position, size and shape of the substance library 201 on the base element 400. If the analysis of the target-probe interaction is carried out using optical detection methods, the lid element 200 is in this case optically translucent and non-fluorescent at least in this area.

The substance libraries 201 may be protein substance libraries, peptide substance libraries, and nucleic acid substance libraries. The protein substance libraries may in particular be antibody libraries, receptor molecule libraries, and membrane protein libraries. The peptide libraries may in particular be receptor ligand libraries, they may be pharmacologically-active peptide libraries and peptide hormone libraries. Nucleic acid substance libraries may in particular be DNA molecule libraries and RNA molecule libraries. In case of DNA molecule libraries, in particular ribosomal DNA sequences of microorganisms may be deposited on the lid element 200. In addition, they may be nucleic acid substance libraries for SNP analysis. Furthermore, they may be protein substance libraries or nucleic acid substance libraries which allow a so-called “expression profiling”. They may also be combinatorial substance libraries.

In this case, the substance libraries 201 are deposited on the carrier element 202 in such a way that they are in contact with the sample space of the resulting chamber. The lid element 200 of the created reaction chamber is thus characterized according to the invention in that it has a detection surface with a substance library on its underneath side and is optically translucent at least in the detection area.

An advantageous embodiment of the invention is that the resulting reaction chamber 500 is sealed and aqueous samples may be heated to temperatures of up to 100° C. over the course of hours without leakage of liquid or evaporation of the samples occurring.

These advantageous effects are achieved through the sealing material properties of the intermediate element 300. In addition, the intermediate element is elastic and repeatedly puncturable with cannulae, wherein the cannulae are extractable and after the extraction of the cannulae a leakage of liquid from the intermediate element does not occur. The intermediate element preferably consists of polydimethylsiloxane (available under the names Sylgard 184 or 182), natural rubber, butadiene rubber, chloroprene rubber, nitrile-butadiene rubber, butyl rubber, isoprene-styrene rubber, polynorbornene rubber, ethylene-propylene rubber, fluor rubber (available under the names Biton, Tecnolflon, Fluorel, Daiel), perfluor rubber (available under the name Klarez), methyl-phenyl-silicon rubber, methyl-vinyl-silicon rubber, methyl-fluor-silicon rubber, fluor-silicon rubber, polysulfide rubber, urethane rubber, polyester or polyether prepolymers on the basis of 4,4′-methylene di(phenylisothiocyanate) or toluene diisocyanate (available under the names Adipren, Elastothane, Genthane, Urepan, Vibrathan).

Within the scope of the invention, the intermediate element 300 is also referred to as septum or sealing septum. The intermediate element 300 is characterized in that it has an enclosed recess 301. Due to this recess 301 that defines the volume of the reaction space (provided by 301) of the reaction chamber 500, both the geometry and the volume of the reaction space may be varied. The reaction space 301 is hereinafter also referred to as sample space or chamber space.

Preferably, a reaction space 301 with volumes between 5 and 100 μL, preferably between 10 and 50 μL or between 15 and 40 μL, between 15 and 35 μL or between 15 and 25 μL is formed by the sealing septum 300.

Depending on the geometry of the recess 301 in the sealing septum 300, substance libraries 201 may be deposited on the lid element 200 in various geometric arrangements, the geometry of the arrangement of the substance library 201 only depending on the geometry of the recess 301 of the sealing septum 300.

The advantageous design of the sealing septum 300 allows an air bubble-free filling of the reaction space 301. The geometry of the reaction space that is defined by the sealing septum 300 is preferably in the shape of a D; another advantageous shape is that of a new moon, a sickle or a tangerine segment.

An advantageous embodiment of the invention is that the geometric shape of the reaction space is defined by the sealing septum 300 and, as a result, may be changed without altering the entire device 1 and may be customized to individual problems.

A further advantageous embodiment of the invention is that the enclosure of the reaction chamber 500 achieved by the sealing septum 300 on the one hand increases the storage life of the chip and, on the other hand, reduces the danger of contamination during the analysis. A further advantageous embodiment of the invention is that depending upon the design of the sealing septum 300, substance libraries 201 with different outer geometric dimensions may be deposited on the lid element 200 and used.

A further advantageous embodiment of the invention is that the sealing septum 300 has a recess of any desired geometry 301. The sealing septum 300 preferably consists of a sealing, elastic material so that the sample chamber may be loaded by repeated puncturing of the sealing septum from the side, the sealing septum being sealed in such a way that there is no liquid leakage after the extraction of the cannulae with which the sample chambers are loaded. The sealing septum 300 in this case preferably consists of materials such as polydimethylsiloxane (available under the names Sylgard 184 or 182), of natural rubber, butadiene rubber, chloroprene rubber, nitrile-butadiene rubber, butyl rubber, isoprene-styrene rubber, polynorbornene rubber, ethylene-propylene rubber, fluor rubber (available under the names Biton, Tecnolflon, Fluorel, Daiel), perfluor rubber (available under the name Klarez), methyl-phenyl-silicon rubber, methyl-vinyl-silicon rubber, methyl-fluor-silicon rubber, fluor-silicon rubber, polysulfide rubber, urethane rubber, polyester or polyether prepolymers on the basis of 4,4′-methylene di(phenylisothiocyanate) or toluene diisocyanate (available under the names Adipren, Elastothane, Genthane, Urepan, Vibrathan).

The base element of the sample chamber 400 is preferably designed in such a way that it possesses an integrated heater/sensor substrate. The heating/sensor substrate is generally a temperature-regulating heating system. Such heating/sensor substrates are described in PCT/EP00/06103.

The base element 400 in this case is at least optically translucent and non-fluorescent. in the sample space area defined by the recess of the sealing septum 300 or in the area defined by the detection surface of the lid element. Preferably, it consists of materials such as Borofloat 33 (available from Schott), quartz glass, monocrystalline CaF₂ (available from Schott), and/or monocrystalline silicon. Through the heater/sensor substrate integrated in the base element 400, the temperature may be adjusted to ±1° C. within a range from 0° C. to 100° C., preferably from 0° C. to 95° C. and/or from 50° C. to 95° C.

In one embodiment of the invention, the substance library 201 is situated on the base element 400. The base element 400 then also has to be optically translucent and non-fluorescent within the area whose size, shape, and position are defined by the detection surface of the substance library 201. If the substance library is situated on a chip and if this chip is affixed to the base element 400, the chip has to be optically transparent and translucent.

In a special embodiment of the invention, the substance library 201 is situated directly on the base element 400. In this case, the base element 400 may have an electrode structure which does not allow the detection of interactions of the target molecules with the probe molecules of the substance library by optical detection methods, but rather by electronically measurable variables such as impedance, conductivity, potential, capacity etc. (U.S. Pat. Nos. 6,013,166, 628,590, 6,245,508, 5,965,452, Tu et al. (2000) Electrophoresis, 21). In this case, neither the base element 400 nor the lid element 200 has to be optically transparent and non-fluorescent in the areas defined by the substance library 201, although they may be.

The layered reaction chamber 500 consisting of the base element 400, the intermediate element 300, and the lid element 200, is also referred to as core unit 500. For the fixation and alignment of the core unit, the base element 400, the intermediate element 300, and the lid element 200 are placed on top of one another in recesses 117 that are mounted in the holding elements 101 and 102 that may be engaged with one another.

By pressing the two holding elements together, the core unit consisting of the base, intermediate and lid element is sealingly compressed. For that purpose, the recesses of the holding elements 101 and 102 that are fixable with one another in a preferred embodiment contain barbs (Widerlager/Widerhaken) 118, pushing the sealing septum 300 to the side. In order not to hinder this process, the sealing septum 300 is constructed in such a way that it possesses expansion joints 302. In order to ensure a secure positioning of the sealing septum 300 in the holding elements 101 and 102 despite the expansion joints 302, the sealing septum has alignment ears 304 at its corners.

In another embodiment, lid element 200, intermediate element 300, and base element 400 may be conglutinated with one another.

In order to inject the thus created hermetically sealed reaction space 301 free of dead volume, at least two cannulae fixed at a defined distance are, at a precise position, inserted from the side into the sealing septum 300. The needles then penetrate into the reaction space 301 at the corners of the flat side of the D-shaped recess or at the corner of the new moon-shaped recess. In this way, the reaction space 301, and thus the reaction chamber 500, have an inlet and an outlet. The sample is now injected into the reaction chamber 500 with a syringe. In the same manner, the chamber may be emptied or the sample fluid may be exchanged with e.g. a rinsing buffer.

The shape of the reaction space 301 is designed fluidically in such a way that bubble-free filling with sample fluid is possible with high reproducibility. After filling, the needles are extracted so that the insertion holes in the elastic sealing septum 300 close up and the sample remains pressure-tight and hermetically sealed in the reaction chamber 500. The entire sample fluid is situated in the reaction space 301 and not in feeding or exit channels—which is the reason why the cartridge 1 works free of dead volume.

Through the hermetic sealing of the reaction chamber 500, the substance library 201, which is sensitive to mechanical stress, is protected against damage. Another advantage according to the invention is that in case of a detection of substances that are highly sensitive to contamination, the reaction space 301 may be filled with protective substances such as protective liquids and protective gases until analysis takes place. Such protective gases are preferably argon, nitrogen, and inert gases. If the surface-bound substance library consists of e.g. RNase sensitive RNA molecules, the sample chamber 500 may be protected with RNase inhibitors (e.g. DEPC-water) until analysis takes place. During the filling with the sample material, the protective substance is removed through simple displacement.

Furthermore, standard substances may be provided in the reaction space 301 during the manufacturing process. For example, a mixture of nucleotides, primers, polymerase and PCR buffer would be suitable for PCR.

An advantageous embodiment of the invention allows for the cooling of the core unit 500. For that purpose, the holding elements 101 and 102 may contain cooling channels 105 that may be operated with different cooling media. The cooling agents are preferably fluorohydrocarbons, R134, ammonia, volatile hydrocarbons such as propane, cooled air, cooled gases such as liquid or gaseous CO₂. This advantageous embodiment allows in particular a precise performance of the PCR.

By using e.g. CO₂ or R134, the sample in the cartridge may be thermostat regulated to temperatures distinctly below room temperature, a mode of operation that is particularly desirable for the hybridization reaction. In an advantageous embodiment of the invention, cooling media are blown onto the core unit 500 via cooling agent inlets 112 and 117 and the cooling agent outlet 116 that are appropriately integrated into the holding elements 101 and 102. By using e.g. CO₂ or another cooling agent R134, the core unit may be cooled to temperatures below room temperature. By means of the heater/sensor substrate 400, a temperature below room temperature may be regulated with a precision of ±1° C. The available operating range of the cartridge is then −30° C. to 100° C., preferably 0° C. to 95° C. and/or 50° C. to 95° C.

One advantageous embodiment of the invention allows for the two holding elements 101 and 102 that are fixable with one another to represent two half shells engaging with one another. The holding elements fixed with one another or the half shells fixed with one another together with the core unit 500 forms a device that is also referred to as cartridge 1.

According to the invention, the cartridge may be assembled from one side by simply positioning the different components that are the upper holding element 101, the lid element 200, the intermediate element 300, the base element 400, and the bottom holding element 102, on top of each other.

The cartridge is advantageously designed in such a way that all media connections (for cooling media 105 and heating system contacts 403) are located on one side 120.

The cartridge is advantageously designed in such a way that it also has a recess 103 on the side where the media connections 120 are located, via which recess 103 the reaction chamber 500 may be loaded by piercing with at least two cannulae from the side into the sealing septum 300.

In an advantageous embodiment of the invention, the recess 103 is designed in such a way that a locating lug 1103 may be inserted into the recess in such a way that it fits snugly. In order to inject the sample into the reaction chamber 500, in an advantageous embodiment of the invention, at least two cannulae that are fixed with a defined spacing may be inserted into the sealing septum 300 from the side and positioned exactly by means of a locating lug 1103 which may be inserted into the recess 103 of the cartridge 1 and two locating holes in the cartridge (needle guide 113). The sample is injected into the reaction space 301 of the sample chamber 500, the sample chamber 500 may likewise be emptied via the two cannulae or the fluid sample may be exchanged e.g. with a rinsing buffer.

In an advantageous embodiment of the invention, the cartridge 1 is designed in such a way that it has snap closures 106 on the side of the recess 103 and the media connections 120. Because of this, it is possible to attach or connect the cartridge 1 to any connector of a defined construction type (e.g. 1000) and to immediately have all media connections available. The connector 1000 corresponding to this advantageous embodiment of the invention has a slide 1100 that carries the insertion cannulae 1201 together with locating lug 1103. The slide 1100 is pressed into the cartridge 1 by a servomotor in order to open the sample chamber 500 for filling or for rinsing. The sample chamber 500 is closed again by pulling out the slide 1100.

Computer-controlled external devices such as pumps and valves for the filling of the cartridge 1 may be connected via the connector 1000. The computer-controlled thermo-regulator with the cartridge 1 is also connected via the connector 1000 to the contacts of the heating element 403. In addition, the computer-controlled cooling agent supply may be connected via the connector 1000 to the medium connection 105 of the cartridge 1 provided for this purpose.

The connector 1000 is preferably constructed flat and small in order to be able to install it in different devices as universally as possible and has suitable mounting holes 1002 and alignment pin holes 1001 for making screw connections and fixations.

In addition, the cooling channel 1300 is made of insulation material in order to protect the cooling media from heating up. If required, the cooling agent is pressed into the cooling channel 105 through a cooling agent tube 1204 which is connected to the insulated cooling channel 1300 via a cooling agent connection 1205.

The connector 1000 possesses an electric cable 1206 and an electric connection 1207 for supplying the cartridge 1 with electricity.

An advantageous embodiment of the invention allows for the fully-automated operation of the cartridge 1 via the connector 1000.

The slide 1100 is flexibly supported by a sliding linear bearing (Gleitlinearlager) 1003 so that the locating lug 1103 may be inserted into the recess 103 of the cartridge 1 provided for this purpose. The cannulae are connected with filling tubes 1202 through which different solutions may be pumped into the sample chamber 500. In order to be able to drive the slide electromechanically, it has a slide rod 1210 that is provided with a thread 1211 to attach the drive. The slide rod 1210 is provided with a mechanical damping 1212 to compensate for jerky motions of the electromechanical drive. Thus, economically priced drives may be used.

Moreover, several of these connectors 1000 may be set up in parallel so that the simultaneous analysis of several samples in different cartridges is possible.

In an advantageous embodiment of the invention, the cartridge is designed in such a way that it possesses alignment pinholes 108 by means of which it can be positioned in a DNA reader so that adjustment of the image field or the focal point becomes unnecessary.

In an advantageous embodiment of the invention, the holding elements 101 and 102 that are fixable with one another are two interlocking half shells that are held together by simple pressing against each other by means of press fit 115.

In other advantageous embodiments of the invention, the two holding elements 101 and 102 of the cartridge are screwed together.

In another advantageous embodiment of the invention, the two holding elements 101 and 102 that are fixable with one another are designed in such a way that they may be conveniently manufactured from plastic by injection molding and are thus inexpensive. The materials used in the manufacture of the holding elements are preferably polycarbonate plastics (available e.g. under the name Makrolon), polystyrenes that may contain glass fibers as aggregate, plexiglass which may be colored or uncolored, or SPS GF30 (available from the company Schulatec).

In an advantageous embodiment of the invention the cartridge 1 is designed in such a way that it may be discarded after one use. For this reason, any form of cleaning after it has been used becomes unnecessary.

The two holding elements 101 and 102 of the cartridge 1 are constructed according to the invention in such a way that they have viewing windows above and below the core unit 500 so that the optical translucency of the reaction chamber is guaranteed.

In an advantageous embodiment of the invention, the cartridge is constructed in such a way that on the side of the holding element 101 that is turned to the read-out optics there is an antireflection structure 109 that suppresses scattered light. This structure preferably has the shape of parallel, narrow grooves (riffling). Other shapes usable as reflection structure are knobs, roughening, and pyramid arrangements. Due to this advantageous property of the cartridge 1, a multitude of optical methods (dark field, incident light, oblique light and transmitted light-fluorescence measurement, confocal fluorescence measurement, luminescence measurement, phosphorescence measurement, absorption measurement) may be utilized for the analysis of the interaction investigated in the sample chamber.

In another advantageous embodiment of the invention, each cartridge 1 is individually identified via a data matrix 600. For that purpose, a dataset is stored in a database while the cartridge is being assembled that in addition to the parameters for the heater/sensor substrate 400 contains information as to how the installed substance library 201 has to be analyzed and how the sample in the cartridge 1 has to be handled for a successful diagnosis. This dataset gets a number that is added on the cartridge in the form of a data matrix 600. The number registered in the data matrix 600 accesses the dataset created during assembly. On the basis of the protocols found there, the sample is processed fully automatically. All the user has left to do is to inject the sample and to make a note of the analysis results.

In another advantageous embodiment of the invention, the sample chamber 500 may be loaded manually by means of a manual filling station 2000 that is subsequently also referred to as injector 2000. This device assumes the function of the connector only for the injection of the sample, and like it has integrated quick-closure connectors 2106.

In particular, it possesses cavities for the charging and venting of the sample chamber 500 of the cartridge 1 as well as cavities for receiving the cartridge 1. Preferably, these can be cavities for receiving a disposable syringe 2401 filled with sample fluid with attached cannula 2402 and a single ventilation cannula 2403, so that during the attachment of the cartridge 1, the cannulae enter contemporaneously into the reaction space 301 of the sample chamber 500. The sample may then be injected into the sample chamber 500 of the cartridge 1, the ventilation of the sample chamber 500 taking place via the ventilation cannula 2403. After loading the sample chamber 500, the cartridge 1 is removed from the injector 2000 and attached to the connector 1000 for further processing. Since the syringe 2401 and the cannulae 2402 and 2403 are disposable articles, contamination of the sample space with undesired substances is avoided.

The manual filling station 2000 consists of two parts, a lid 2200 and a body 2100, which possess the appropriate recesses for the fixation of the device according to the invention 1, a filling unit, and a ventilation unit. The filling unit is preferably a syringe with cannula 2401 and 2402 and the ventilation unit is a cannula 2403. Lid 2200 and body 2100 may be affixed to one another by means of any device. This fixation preferably occurs by means of magnets.

In principle, the device according to the invention 1 may be used for all test methods that are based on the specific interaction of a target molecule with a probe that is fixed on a microarray. These interactions may be protein-protein interactions, protein-nucleic acid interactions, and nucleic acid-nucleic acid interactions.

The device according to the invention 1 is preferably used for testing procedures that are investigations of the interaction between proteins or peptides with an antibody library that is fixed on a chip. In another preferred application, the device according to the invention is used for microarray-based studies of interactions between a target nucleic acid and a nucleic acid probe. In an especially preferred use, the device according to the invention is used for the detection of microorganisms in clinical samples.

In another especially preferred embodiment, the device according to the invention 1 is used for the detection of the presence of DNA sequences. From the detection of certain DNA sequences, for example the presence of pathogens and their resistances against therapeutic agents may be deduced. Especially preferred is also the use of the device 1 for the determination of the genetic state of cells or organisms such as the detection of mutations that lead to hereditary diseases (e.g. mucoviscidosis, phenylketonuria, infertility etc.) or the detection of polymorphisms. A field of application that is also preferred is the detection of genetic differences that lead to the identification of individuals (e.g. applications in the field of forensics, for paternity tests, among other things).

The detection of the interaction between probes and targets may generally occur through common methods such as optical analysis using fluorescent markers such as Cy3, Texas Red etc., through radioactive markers, or also through chemical reactions such as silver-precipitation (WO 98/04740).

Especially preferred is also the use of the device for the detection of the physiological state of cells e.g. by expression profiling. In this case, linear amplification is preferred, for example by linear PCR amplification.

Especially preferred is also the use of the device in combination with other amplification methods that require a cyclic temperature regimen in order to be carried out, such as the ligase chain reaction (LCR) or ligase detection reaction (LDR), in particular when this is combined with an array-based analysis.

The device according to the invention allows the fully automated, temperature-controlled and flow-controlled performance of test methods based on microarrays. The device according to the invention further allows the simultaneous performance of microarray-based test methods and a PCR without reprocessing of the intermediates.

The device according to the invention will preferably be used to simultaneously amplify nucleic acids by PCR and to analyze the products of the PCR by a microarray-based test in which nucleic acids are utilized as probes.

Reactions such as the ligase chain reaction (LCR) and/or the ligase detection reaction (LDR) may also be carried out in the device according to the invention 1.

The construction of the device 1 according to the invention allows the cost-effective manufacture of a disposable cartridge that may be used to carry out microarray-based test methods.

The following examples are intended to illustrate the invention without limiting it in any way.

### EXAMPLE 1

### PCR

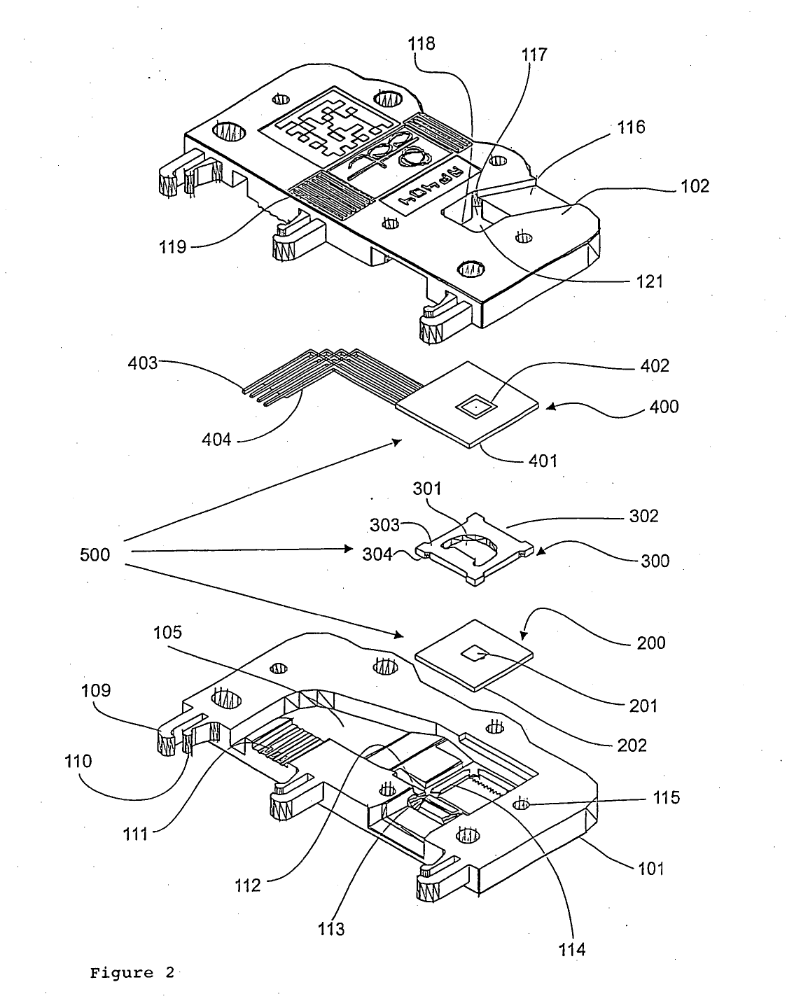

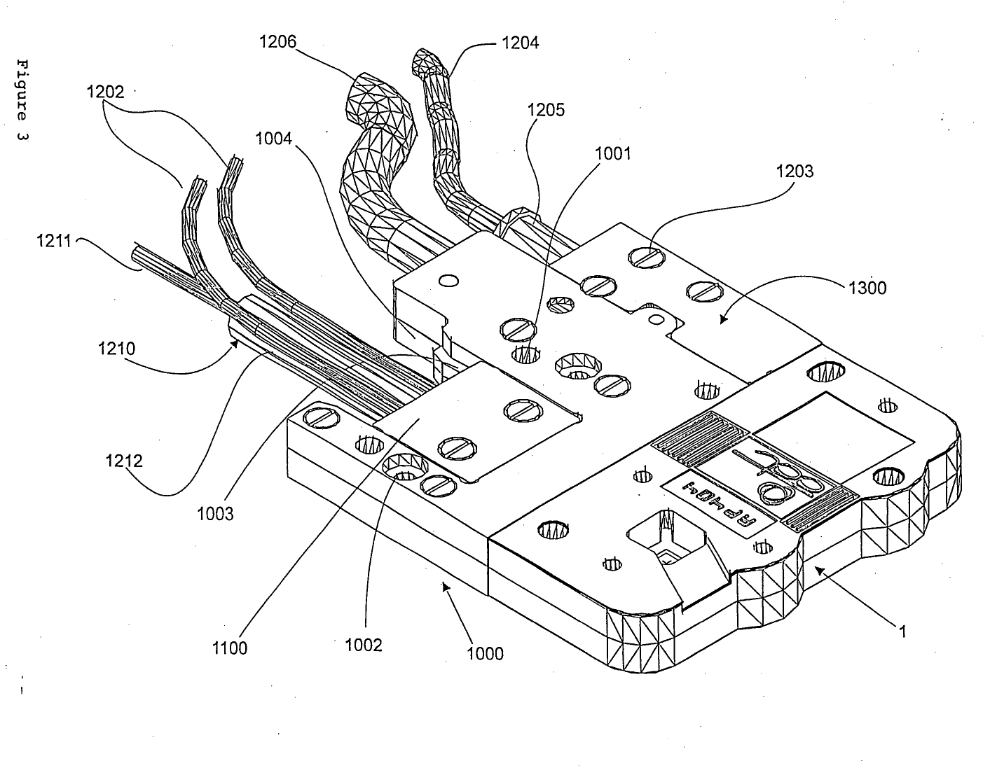

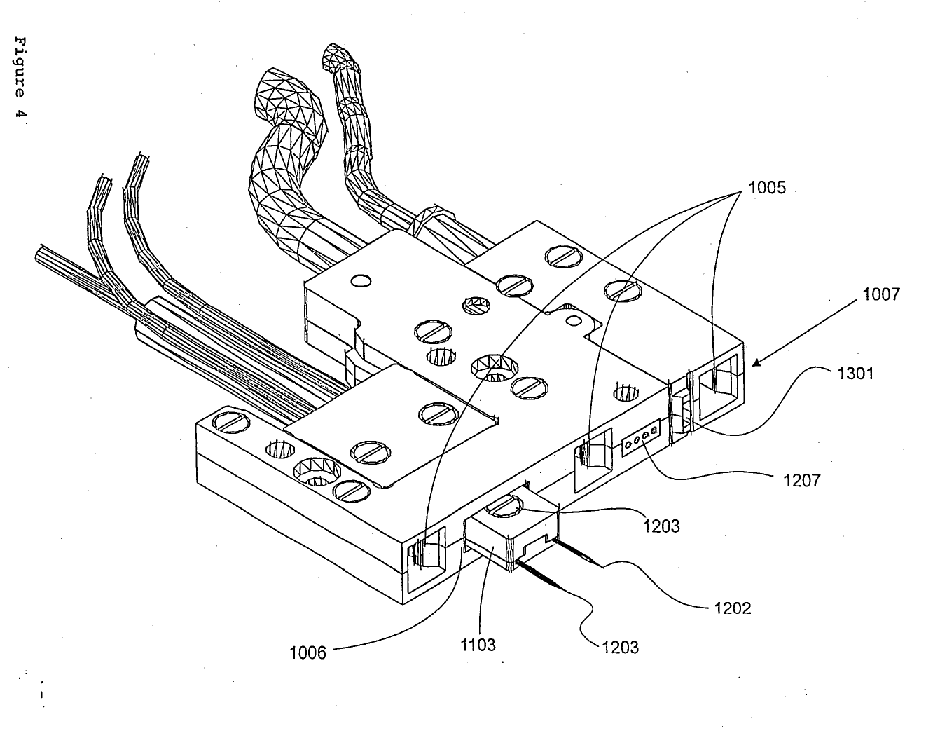

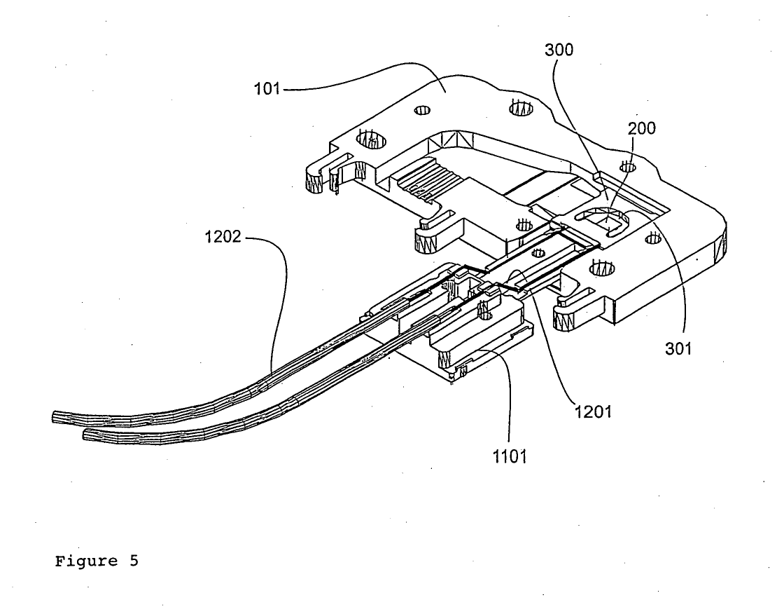

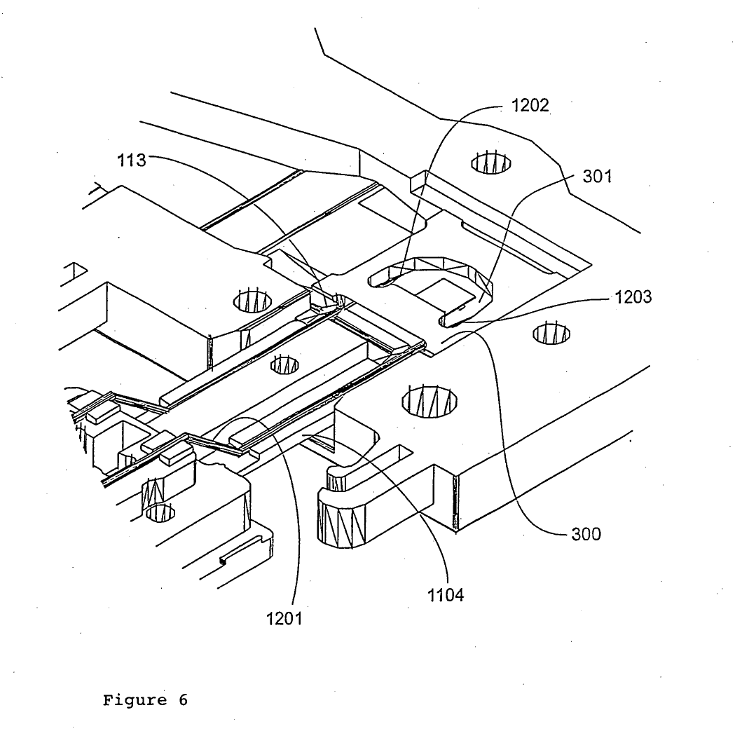

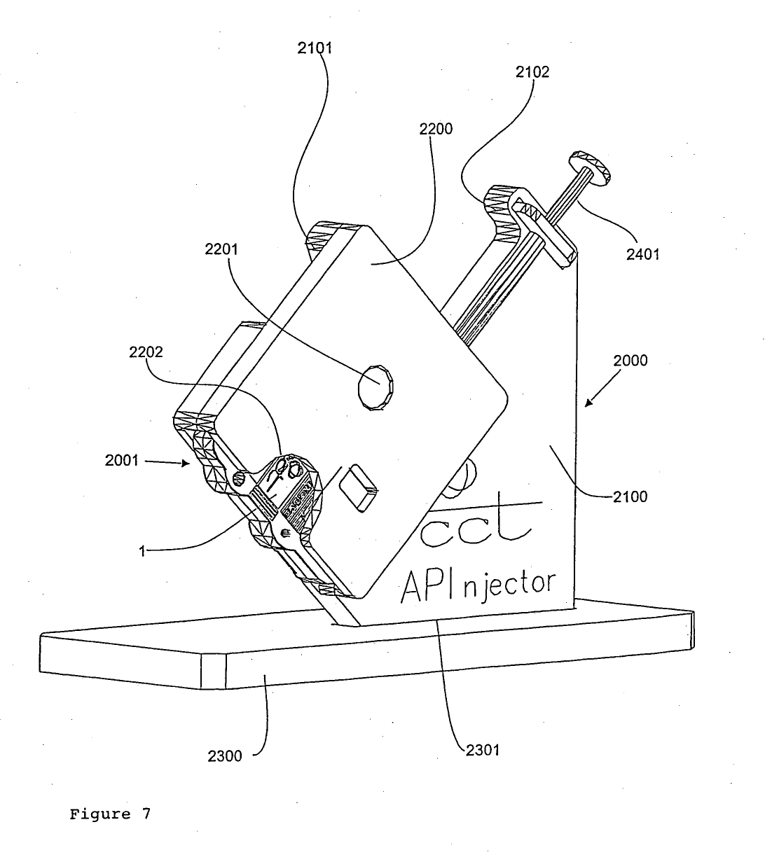

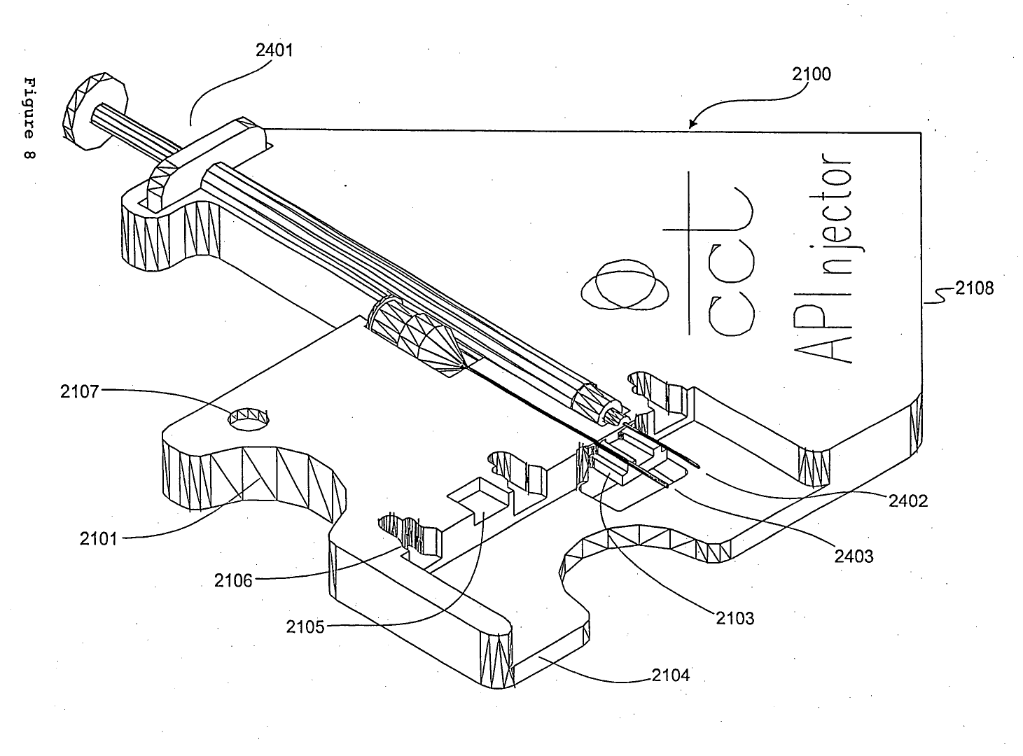

A cartridge 1 was assembled according to FIG. 2. At the same time all technical data concerning this cartridge as well as protocols were stored in a database. The cartridge was assigned an individual number that allows the automatic linking of the cartridge 1 with the corresponding dataset in the database. The number was printed as data matrix 600 and glued on the cartridge 1.

A PCR mixture consisting of 1 μL of genomic DNA of Corynebacterium glutamicum (5 pg/μL), 1 μL primer (AGA GTT TGA TCC TGG CTC AG) (10 pg/μL), 1 μL primer (TAC CGT CAC CAT AAG GCT TCG TCC CTA) (10 pg/μL), 1 μL MgCl₂ (25 mM), 5 μL PCR buffer, 1 μL 50 fold dNTP (10 mM per base), 0.5 μL Taq-polymerase (5 units/pL), and 39.5 μL water was drawn in an injection syringe 2401 with cannula 2402.

Injection syringe and ventilation cannula 2401, 2402, and 2403 were placed into the body 2100 of the injector 2000, the lid 2200 was put on and the cartridge 1 was slid into the cartridge pocket 2001. 20 μL of the PCR mixture were then injected into the sample chamber 500 and the cartridge 1 was removed from the injector 2000.

The remainder of the PCR mixture was put into reaction tubes for the amplification in a conventional thermocycler and amplified.

The cartridge 1 was attached to the connector 1000 and the individual cartridge number encoded in the data matrix 600 was read out and automatically transmitted to the operating program. With this number, the technical data as well as protocols required for the PCR were read out from the database. The technical data for the temperature regulation were transmitted to the temperature controller. The slide 1100 was not slid into the cartridge 1 so that the reaction space 301 remained closed. The PCR was carried out in the cartridge using the following temperature protocol: initial denaturation for 240 s at 45° C. 30 elongation cycles with 60 s at 95° C., 60 s at 58° C. and 150 s at 72° C. each as well as a final extension of 420 s at 72° C.

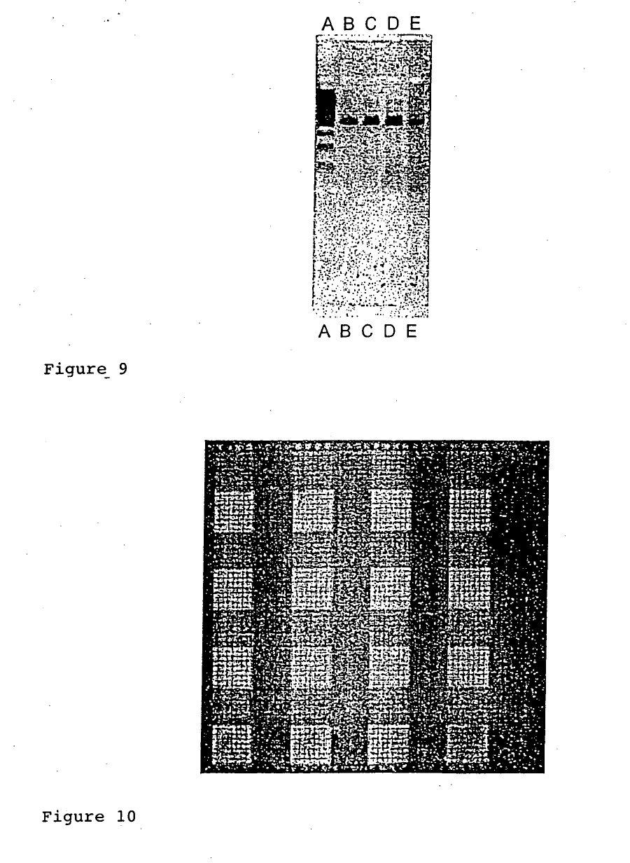

To speed up the cooling times, compressed air was pumped as cooling medium into the cartridge through the cooling agent tube and the insulated cooling channel. After the PCR, the slide 1100 was slid into the cartridge 1 in order to open the sample chamber 500 and the PCR sample was pumped out. The sample was loaded on an electrophoretic gel in order to obtain proof of the functionality of the cartridge. The success of the experiment in comparison with the results in a conventional thermocycler is documented in FIG. 9.

### EXAMPLE 2

### Hybridization and PCR

A cartridge 1 was assembled according to FIG. 2. At the same time all technical data concerning this cartridge as well as protocols were stored in a database. The cartridge 1 was assigned an individual number that allows the automatic linking of the cartridge 1 with the corresponding dataset in the database. The number was printed as data matrix 600 and glued on the cartridge 1.

The lid element 200 built into in the cartridge, which lid element is also referred to as array, carried a substance library consisting of 4 different probes and that was arranged on the surface in the pattern of a chessboard. Each element of the array had a size of 256×256 μm. Each probe was arranged redundantly, i.e. each on 16 spots. Due to the surface structure, the individual spots have a raster scan. The DNA library consisted of the sequence P1 (complementary to the PCR fragment) and three different deletion variants:

P1: 5′ CCTCTGCAGACTACTATTAC 3′
P1 del9_11: 5′ CCTCTGCAATACTATTAC 3′
P1 del10_12: 5′ CCTCTGCAGCACTATTAC 3′
P1del9_10_11_12: 5′ CCTCTGCAACTATTAC 3′

PCR mixture comprising consisting of the following components was drawn into an injection syringe 2401: 5 μL Advantage2 PCR buffer (Clontech, Palo Alto, USA), 1 μL dNTP Mix 20 mM, 1 μL Taq-polymerase (Advantage2, Clontech, Palo Alto, USA), 1 μL Primer P1 (10 pmol/μL) (5′ CCTCTGCAGACTACTATTAC 3′) (MWG, Ebersberg, Germany), 1 μL Primer P2 (10 pmol/μL), coupled with the fluorescent dye Cyanine 3 at the 5′-end (5′ CCTGAATTCTTGCTGTGACG 3′) (MWG, Ebersberg, Germany), 1 μl Template 106-mer PCR product (1 ng/μL) with the sequence 5′ CCTCTGCAGACTACTATTACATAATACGACTCACTATAGGGATCTGCACGTATACTTCTATAGTGTCACCTAAATAGGCAGTCTGTCGTCACAGCAAGAATTCAGG3′, 40 μL deionized water.

Injection syringe and ventilation cannula 2401, 2402, and 2403 were placed into the body 2100 of the injector 2000, the lid 2200 was put on and the cartridge 1 was slid into the cartridge pocket 2001. 20 μL of the PCR mixture were then injected into the sample chamber 500 and the cartridge 1 was removed from the injector 2000.

The cartridge 1 was contacted via the connector 1000, the individual cartridge number encoded in the data matrix 600 was read out and automatically transmitted to the control program. With this number, the technical data as well as protocols required for the PCR were read out from the database. The technical data for the temperature regulation were transmitted to the temperature controller. The slide 1100 was not slid in so that the reaction space 301 of the cartridge 1 remained closed. The PCR was carried out in the cartridge using the following temperature protocol:

Initial denaturation 120 s at 95° C., 30 elongation cycles with 35 s at 95° C., 40 s at 42° C. and 40 s at 72° C. each, final extension of 240 s at 72° C.

To speed up the cooling times, compressed air was pumped into the cartridge 1 as cooling medium through the cooling agent tube and the insulated cooling channel.

After the PCR, the PCR product was hybridized to the surface-bound DNA library on the DNA array. For that purpose, the cartridge was heated to 95° C. for 5 min. and then incubated for 1 h at 30° C. A rinsing process followed in order to remove non-specifically bound DNA from the surface and unbound fluorophores from the cartridge. For that purpose, the slide 1100 was slid into the recess 103 of the cartridge 1 and the PCR sample in the sample chamber 500 was replaced by continuous pumping of 500 μL of washing buffer 1 (2×SSC, 0.2% SDS) (flow rate approx. 0.1 mL per minute), the cartridge 1 being kept at 30° C. The cartridge was then rinsed with 500 μL washing buffer 2 (2×SSC) with the same flow rate and temperature. At the end of the rinsing process, the sample chamber 500 remained filled with washing buffer 2. The fluidic connections were removed from the sample chamber 500 by moving the slide 1100.

The hybridization signals were detected in washing buffer 2 (2×SSC) under a Zeiss fluorescence microscope (Zeiss, Jena, Germany). The excitation occurred in the incident light with a white light source and a set of filters suitable for cyanine 3. The signals were recorded with a CCD camera (PCO-Sensicam, Kehlheim, Germany). The exposure time was 5000 ms (FIG. 10).

Reference Number List

1 cartridge
101 upper holding element
102 lower holding element
103 recess for the incorporation of a lug/slide
104 viewing window
105 medium connection for cooling liquids
106 snap-fit
108 alignment pin holes
403 contacts for heating element
120 media connection side
109 antireflection structure
600 data matrix
117 cooling channel outlet
118 barb (Widerlager/Widerhaken)
400 base element with integrated heater/sensor substrate
401 carrier of the integrated heater/sensor substrate
402 optically translucent recess
403 contacts for heater/sensor substrate
404 contacts for heater/sensor substrate
300 sealing, elastic, repeatedly puncturable intermediate element
301 recess enclosed in 300, defines reaction space
302 expansion joints
304 alignment ears
200 lid element
202 lid carrier element
201 substance library or chip carrying substance library
500 core unit or chamber or reaction chamber or sample chamber
105 cooling channel
109 snap-fit
110 snap-fit
111 recess for heating/sensor substrate contacts 403
112 cooling agent inlet
116 cooling agent outlet
117 cooling agent inlet
115 press fit
1000 connector
1100 slide
1103 locating lug
1001 alignment pin holes
1002 mounting holes
1006 electric cable
1207 electrical connection
1202 filling tubes
1210 slide rod
1211 thread
1212 damping
1204 cooling agent tube
1205 cooling agent connection
1300 cooling channel
1201 insertion cannulae
2000 manual filling station
2106 quick-closure connector
2401 disposable syringe
2404 cannula
2403 ventilation cannula
2402 tip of a cannula
2403 tip of a cannula
2100 manual filling station body
2200 manual filling station lid
2101 recessed grip
2102 recessed grip

1. A device for holding a substance library carrier, comprising two holding elements that are fixable with each other, and that form a layer composite comprising:
(i) a lid element having a detection surface with a substance library on its underneath side and being optically translucent at least in an area of the detection surface,
(ii) a sealing intermediate element having an enclosed recess; and
(iii) a base element being optically translucent at least in an area of the detection surface of the lid element,
wherein the lid element, the intermediate element and the base element together form an optically translucent chamber having a chamber space.

2. A device according to claim 1, wherein the base element comprises an integrated heating-temperature sensor device.

3. A device according to claim 1, wherein the base element comprises Borofloat 33, silica glass, monocrystalline CaF₂ and/or monocrystalline silicon.

4. A device according to claim 1, wherein the lid element comprises glass, Borofloat 33, quartz glass, monocrystalline CaF₂, monocrystalline silicon, phenylmethylmethacrylate and/or polycarbonate.

5. A device according to claim 1, wherein the intermediate element is elastic and can be repeatedly punctured from the side by cannulae, and that the chamber space remains sealingly closed upon extraction of the cannulae.

6. A device according to claim 1, wherein the intermediate element comprises polydimethyl siloxane, natural rubber, butadiene rubber, chloroprene rubber, nitrile butadiene rubber, butyl rubber, isoprene-styrene rubber, polynorbornene rubber, ethylene-proplyene rubber, fluor rubber, perfluor rubber, methyl-phenyl-silicon rubber, methyl-vinyl-silicon rubber, methyl-fluor-silicon rubber, fluor-silicon rubber, polysulfid rubber, urethane rubber, polyester or polyether prepolymers on the basis of 4,4′-methylenedi(phenylisothiocyanate) or toluenediisocyanate.

7. A device according to claim 1, wherein the recess defines a geometrical form of the chamber space.

8. A device according to claim 1, wherein the chamber space may be filled free of air bubbles.

9. A device according to claim 1, wherein the chamber space is formed in the shape of a D, a new moon, or a sickle.

10. A device according to claim 1, wherein the chamber may be cooled.

11. A device according to claim 1, wherein the two holding elements are half shells engaging with one another and which are held together by press-fit when pressed together.

12. A device according to claim 1, wherein the holding elements each comprise channels for cooling the chamber.

13. A device according to claim 1, wherein the holding elements each comprise a recess for receiving a slide or lug for loading the sample chamber.

14. A device according to claim 13, further comprising a media connection for heating the chamber, and a media connection for cooling the chamber, and a recess for receiving an injection apparatus, and wherein the media connections and the recesses are located on one side of the device.

15. A device according to claim 1, which is attached to a connector.

16. A device according to claim 15, which may be operated fully automatically through the connector.

17. A device according to claim 1, which is attached to a manual filling station.

18. A device according to claim 1, which contains a protein library.

19. A device according to claim 18, wherein the protein library is an antibody library, a receptor protein library or a membrane protein library.

20. A device according to claim 1, which contains a peptide library.

21. A device according to claim 20, wherein the peptide library is a receptor ligand library, a library of pharmacologically active peptides or a library of peptide hormones.

22. A device according to claim 1, which contains a nucleic acid library.

23. A device according to claim 22, wherein the nucleic acid library is a DNA molecule library.

24. A device according to claim 22, wherein the nucleic acid library is an RNA molecule library.

25. A method of carrying out a microarray-based test, comprising (a) providing a device according to claim 1, wherein the substance library contains a microarray having fixed thereon probes that bind a target molecule; (b) introducing a sample suspected of containing the target molecule into the device; and (c) detecting presence or amount of interaction between the probes and the target molecule.

26. A method according to claim 25, wherein the substance library contains a protein library.

27. A method according to claim 26, wherein the protein library is an antibody library, a receptor protein library or a membrane protein library.

28. A method according to claim 26, wherein the sample contains nucleic acids.

29. A method according to claim 26, wherein the sample contains proteins.

30. A method according to claim 25, wherein the substance library contains a peptide library.

31. A method according to claim 28, wherein the peptide library is a receptor ligand library, a library of pharmacologically active peptides or a library of peptide hormones.

32. A method according to claim 25, wherein the substance library contains a nucleic acid library.

33. A method according to claim 32, wherein the sample contains nucleic acids.

34. A method according to claim 33, wherein the nucleic acids are obtained from an organism.

35. A method according to claim 33, wherein the nucleic acids are obtained from a cell.

36. A method according to claim 33, wherein the nucleic acids are obtained from a microorganism.

37. A method according to claim 36, wherein the microorganism is pathogenic.

38. A method according to claim 32, wherein the nucleic acid library is an RNA molecule library.

39. A method according to claim 32, wherein the nucleic acid library is an DNA molecule library.

40. A method according to claim 33, wherein said sample comprises a polymerase chain reaction (PCR) mixture comprising said nucleic acid, at least one primer, nucleotides and a polymerase, such that said nucleic acids also undergo amplification via PCR.

41. A method according to claim 40, wherein said PCR mixture comprises two primers, one of which is fluorescently labeled.

42. A method according to claim 33, wherein said nucleic acids also undergo a ligase chain reaction (LCR).

43. A method according to claim 33, wherein said nucleic acids also undergo a ligase detection reaction (LDR).

44. A first device for filling a second device for holding a substance library carrier, wherein the second device comprises two holding elements that are fixable with each other, and that form a layer composite comprising:
(i) a lid element having a detection surface with a substance library on its underneath side and being optically translucent at least in an area of the detection surface,
(ii) a sealing intermediate element having an enclosed recess; and
(iii) a base element being optically translucent at least in an area of the detection surface of the lid element,
wherein the lid element, the intermediate element and the base element together form an optically translucent sample chamber having a chamber space,
and wherein the first device comprises a body and a cover fixable to the body, wherein the body contains recesses for a filling unit, a ventilation unit and the second device, and wherein the recesses are arranged such that the sample chamber of the second device may be loaded and vented through puncturing of the intermediate element from its side.

45. A device according to claim 44, wherein the filling unit comprises a syringe with a first cannula, and wherein the ventilation unit comprises a second canula.


SEQUENCE LISTING (8 sequences)

SEQ ID NO: 1 - DNA, 20 bp, Artificial Sequence
  Description of Artificial Sequence Synthetic primer
agagtttgatcctggctcag

SEQ ID NO: 2 - DNA, 27 bp, Artificial Sequence
  Description of Artificial Sequence Synthetic primer
taccgtcaccataaggcttcgtcccta

SEQ ID NO: 3 - DNA, 20 bp, Artificial Sequence
  Description of Artificial Sequence Synthetic oligonucleotide
cctctgcagactactattac

SEQ ID NO: 4 - DNA, 18 bp, Artificial Sequence
  Description of Artificial Sequence Synthetic oligonucleotide
cctctgcaatactattac

SEQ ID NO: 5 - DNA, 18 bp, Artificial Sequence
  Description of Artificial Sequence Synthetic oligonucleotide
cctctgcagcactattac

SEQ ID NO: 6 - DNA, 16 bp, Artificial Sequence
  Description of Artificial Sequence Synthetic oligonucleotide
cctctgcaactattac

SEQ ID NO: 7 - DNA, 20 bp, Artificial Sequence
  Description of Artificial Sequence Synthetic primer
cctgaattcttgctgtgacg

SEQ ID NO: 8 - DNA, 106 bp, Artificial Sequence
  Description of Artificial Sequence Synthetic oligonucleotide
cctctgcagactactattacataatacgactcactatagggatctgcacgtatacttctatagtgtcacctaaataggcagtctgtcgtcacagcaagaattcagg